(19) United States
(12) Patent Application Publication
(10) Pub. No.: US 2004/0133411 A1
(43) Pub. Date: Jul. 8, 2004

(54) Automated Transit System

(75) Inventor: Derrick T. Babb, Orlando, FL (US)

Correspondence Address: DERRICK T. BABB, 751 EVANGELINE AVENUE, ORLANDO, FL, 32809, US

(73) Assignee: Derrick T. Babb, Orlando (US)

(21) Appl. No.: 10/248,319

(22) Filed: Jan. 8, 2003

(51) Int. Cl. G06F 9/45

(52) U.S. Cl. 703/22

(57) ABSTRACT

The methodology of deploying a mass transportation system to provide effective on-demand service is presented. The natural constraints of such service provision require a new model of transit system operation, operating techniques, a wide array of new technological developments, their unique transit application, and innovative new vehicle designs.

### BACKGROUND OF INVENTION

1. Field of the Invention

This invention relates generally to the field of transportation system design and operation. More particularly, the invention relates to a novel transit operating model, techniques, technologies, and vehicle designs for providing effective on-demand, multimodal service using mass transportation.

2. Description of the Art

A serious, growing dilemma is apparent in transportation nationwide. Present transportation solutions, ranging from highway expansion to Light Rail and Maglev, exhibit prohibitive capital costs. Progress is further impinged by factors of continued growth outstripping new infrastructure development, and fears of investing millions into alternative solutions that may well become idle infrastructure without the presence of an effective transit system to deliver passengers the “last mile.” An analytic analysis of the situation results in a well-defined set of constraints for developing a solution for 21^{st} century mass transportation. These constraints include:

Optimal utilization of existing roadway infrastructure

Provision of effective on-demand, close-proximity service

Establishment of temporal and utility competitive advantages over the automobile

Efficient dynamic, decentralized operation

Of central importance is the later constraint, as it defines the model of operation in which a 21^{st} century transit system must function. This model is a complex challenged to overcome. It will be demonstrated how distributed operation exhibits a serious drawback in terms of efficiency: redundant routes form and require excess resources across the entire system. To mitigate this issue, the transit system must be capable of dynamically consolidating passengers with common routes onto fewer vehicles. Such a concept, however, has never been employed. Every passenger would need to be interfaced into the transit system's operational software, managing and coordinating the process of dynamic transfer. Secondly, providing a means of making rapid transfers is paramount to system performance and minimizing impact to travel time. The ideal solution would be a means of making “in-motion” transfers.

### SUMMARY OF INVENTION

The methodology of deploying a mass transportation system to provide effective on-demand service is presented. The natural constraints of such service provision require a new model of transit system operation, operating techniques, a wide array of new technological developments, their unique transit application, and innovative new vehicle designs.

The enabling innovation of this multifaceted invention is a method for overcoming the inefficiencies of dynamic transit system operation, which are becoming increasingly apparent in, for example, paratransit system scalability. Utilizing the unique approach of compiling travel data to determine like passenger routes in close temporal proximity, in combination with methods of direct passenger interfacing and movement instruction, the concept of coordinating impromptu transfers and like route consolidation to enable efficient, dynamic, and decentralized operation has been formed. The abstract concept is further extensible in a number of embodiments which will be discussed. These embodiments include the streamlined integration and redeployment of both private and public transportation systems, accessed through the same Global Transport Service (GTS) framework, and new methods for coordinated ground vehicle operation, including concepts termed expansive and intermetro travel.

Also described are new operating techniques, transit technologies, and vehicle designs formed to perfect the performance and efficiency of this proposed transit system. A unique concept of in-motion vehicle docking and passenger transfer will be essential in establishing a transit system, deployed over existing roadway infrastructure, capable of rapid like route consolidation optimization and effectively handling unilateral ridership. It is but one of many novel transit techniques, technologies and vehicle designs that will be present.

### BRIEF DESCRIPTION OF DRAWINGS

A better understanding of the present invention can be obtained from the following detailed description in conjunction with the following drawings:

FIG. 1, Transfer Bridge: Automated Transit System

FIG. 2, Automated Tram: A TS Stage II Operation

FIG. 3, Tram Train: A TS Stage II Operation

### DETAILED DESCRIPTION

The multifaceted invention described below provides the operating model, techniques, technologies, and vehicle designs for a next generation, multimodal transit system capable of providing on-demand service, otherwise known as demand-responsive transit (DRT), with unparallel performance and efficiency.

In the following description, the details and components of the invention are presented in linear fashion, from the base concept of overcoming dynamic, decentralized operation through algorithmic analysis that leads to like route consolidation, to the full-scale concept embodiment, incorporating wholly new transit techniques, technologies and vehicles designs. In addition, for the purpose of explanation, detailed operational characteristics and extensible functionality of the system are explored. It will be apparent, however, to one skilled in the art that embodiments of the system may be practiced without some of these specific details.

Overcoming Dynamic, Decentralized Operation Inefficiencies

Chaos Theory provides an adequate proof to explain the natural inefficiencies of many distributed systems: subtle changes and demands on a system result in exponential difficulties for managing performance and efficiency. When employing of dynamic, decentralized operating model for transit systems, fundamental for on-demand service, redundant routes form throughout the network due to the chaotic nature of operation. Redundancy, in this context, is the resultant of passengers traveling on differing vehicles, however along like routes and in close temporal proximity. Subsequently, in such systems, excess resources are required to provide effective service, and service thus becomes increasingly cost prohibitive as ridership gains. This fact can be substantiated by the ineffective scalability of existing paratransit systems.

Analytic analysis of natural dynamic, decentralized operation inefficiencies leads to a singular pragmatic solution: dynamically determine like routes among passengers that are in close temporal proximity and dynamically schedule impromptu passenger transfers to consolidate these like routes, optimizing system performance and utilization. At present, an embodiment of this concept exists neither in theory nor practice. This process of like route consolidation (LRC) optimization is cornerstone to the next generation transportation system presented here. The remainder of the invention defines varying techniques, technologies, and vehicle designs to enable and perfect this innovative solution to a natural, and previously unanswered, constraint to providing effective on-demand transportation service.

Operating Model Explored

Why is LRC optimization essential to mass transportation? Consider that in one year's time 10% of every rider in the United States will use public transportation. First, the proposed transit system providing such service will have to be relatively cost effective, requiring virtually no new infrastructure development. This will be a distinction over alternate transit solutions such as Light Rail and Maglev. Second, the system must present a specific set of benefits to the rider to attract such patronage, namely pleasing aesthetics and time and cost competitive advantages equal to or exceeding the automobile. Third, the system must be operationally capable of facilitating this increased load (presently between 1.7-1.8% nationwide). Lastly, to garner broad support, the system must facilitate rural and outlying regions in addition to providing unparallel service to the physically impaired.

Essentially, this system must utilize existing roadway infrastructure to deliver service, thus must primarily utilize ground based vehicles moving in mixed traffic. On-demand service, delivered in close proximity, i.e. one's doorstep, must be the case. The system must be highly adaptive thus dynamic and decentralized in nature. It must be scalable, using a heterogeneous mix of small and large scale vehicles operating in differing modes, i.e. cellular vs. long-haul. These requirements are reinforced by the challenge of overcoming sprawl, servicing rural and outlying regions, and delivery service within close proximity of patrons. To coordinate such a complex transit system, an effective software and communications infrastructure must be development and deployed that integrates both individual vehicles and, as we will discuss further, individual passengers. LRC optimization will provide the essential method of mitigating the natural inefficiencies of this depicted transit system, to maintain a high degree of system performance and efficiency.

Implementation of this multifaceted invention, as will be presented, is multi-staged. In Stage I Operation, the invention embodiment will integrate and redeploy mostly existing technologies, vehicles, and public/private transportation systems. Stage I Operation is anticipated to handle a moderate level of ridership effectively and, at the least, compete, if not exceed, both the temporal and utility performance of the automobile. Stage II Operation employs the development of new transit operation techniques, technologies and vehicles designs to rapidly deploy fleets capable of unilateral ridership and distinct temporal and utility competitive advantages over the automobile.

In Stage I Operation, the invention embodiment will utilize a heterogeneous fleet of vehicles of varying scale to provide service, at times in coordination with existing static systems such as commuter rail. The transit operational software, herein termed the Global Transport Service (GTS) will provide, though be not limited to, the abstract computer platform for integrating independent transit systems, providing trip planning services for patrons, and the mechanism for passenger interfacing that will be discussed momentarily. Passengers will be capable of either preplanning or requesting for transit service in real-time using GTS. With current and historic transit data, the GTS software will algorithmically determine best practices (optimal dispersion and general operation) for existing resources. In Stage I, the heterogeneous vehicle fleet will be composed mainly of buses and passenger vans.

To conceptualize one embodiment of operation, consider small radius operation areas dynamically determined by GTS, approx. 3 km² in area. For each of these areas a passenger van is deployed to provide service. The function of each van is to pickup and deliver passengers roughly within each conceptualized operations area, to effectively provide short distance travel (i.e. to the local market), and to consolidate groups of passengers to be captured and offloaded by larger scale vehicles. Along arterial routes, GTS will have deployed these larger scale vehicles and will coordinate smaller scale vehicle operations to coincide with captures and offloads by them.

At any point in operation, GTS may determine optimal times for transfer between any set of vehicles. Additionally, an intrinsic concept known as expansive travel may be deployed, where GTS determines and consolidates a group of passengers traveling like routes of longer distances and allocates a vehicle to travel with minimal or no stopping. Additionally, GTS can deploy the concept of intermetro travel; consolidating passengers from across the local transit system asynchronously onto one vehicle, sending it to a distant metropolitan area, and conversely delivering passengers to their final destinations asynchronously on-board the remote transit system. As will be discussed, GTS would provide the platform for streamlined coordination and fare management for such an embodiment.

This proposed model of operation can be likened to a large-scale embodiment of Bus Rapid Transit (BRT). The system is effectively limiting the number of stops incurred by any one passenger, so that travel times onboard the system can more effectively compete with the automobile. With the incorporation of light switching services, strategically dedicated lanes, and other Intelligent Transportation System (ITS) concepts, the system can provide a distinct temporal competitive advantage. Efficient utilization will result in an equally important utility competitive advantage. The end result is anticipated to be an appealing transit solution, low cost and rapidly deployable, that can service large numbers and transport the same across a large, geographically dispersed area with unparallel performance.

Stage II Operation involves embodiments of truly innovative transit techniques, technologies and vehicle designs that will further enhance the performance and efficiency of the presented transit system, and potentially engender unilateral ridership. Utilizing present transit techniques, technologies, and vehicles inherits a limiting factor to the solution LRC optimization provides for overcoming distributed, decentralized operation inefficiencies. With both performance and efficiency primarily dependent upon the rapid transfer of passengers, at a moderate level of ridership, the conventional embodiment should prove effective. However, growth beyond a moderate ridership will begin to degrade performance as the system approaches the plateau created by requiring vehicles to stop in making consolidations. The natural solution to this challenge is to develop a means of transferring passengers while in-motion. In Stage II Operation, truly novel transit techniques, technologies, and vehicle designed will be employed to do just this.

Passenger Interface

The paramount technical challenge involved in implementing the proposed dynamic, decentralized operating model is directing passengers as the GTS software dynamically determines best practices. There is a plethora of designs and concepts for integrating passengers into travel services. For example, dial-a-ride type services (Dial 1995), online services (www.travelocity.com), wireless devices (Paul 2000), schedule displays (i.e. flight schedules), and so on. These approaches offer a wide variety of practical services, such as requesting service, notification of eminent service provision, determination of passenger location, providing direction from one relatively static trip leg to another, and so on.

Novel about this invention is the concept of directly interfacing passengers into the GTS software while on-board the transit system and providing real-time direction as best practices are determined. Example embodiments of a complete system could include a phone/internet/kiosk interface to schedule service, utilization of contactless smart cards to track passenger movements while onboard (i.e. RFID), and voice notification and video displays to provide real-time direction. Alternatively, a wireless device could be developed to provide the function of the passenger interface and real-time movement instruction. Furthermore, the method of passenger direction could be based on either persons, destinations, or both.

Global Transport Service

An intricate component of this invention is the software and communications (SC) infrastructure necessary to coordinate the presented transit system. The central software component is known as the Global Transport Service (GTS). As discussed, this component will provide, though be not limited to, the software facilities for abstract transit system integration and coordination, global passenger account management and trip planning services, and an abstract mechanism for developing varying types of passenger interfaces.

The purpose of the communications component of the SC infrastructure is to connect all elements of the transit system into the software component. The means of accomplishing this goal may vary, though could included utilization of GSM, GRPS, and mesh network technologies.

Numerous services have been developed that provide an interface to a broad range of travel services. Internet services such as expedia.com and travelocity.com are excellent examples. Of even greater technical merit are services that coordinate multimodal transit service, such as pti.org.uk, which integrates airlines with the London Underground. What is unique about this invention and its supporting SC infrastructure is the functionality of providing on-demand service across a multimodal system and the application of LRC to optimize performance and efficiency under dynamic, decentralized operation.

Advanced Technologies

Safe and effective vehicle automation in mixed traffic, technologies that enable rapid passenger consolidation, and novel new vehicle designs have been formed to support and propel the potential of this transit system.

Logic Driven Navigation (LDN)

The state-of-the-art in vehicle automation is limited to systems that employ buried wires or magnets, sensors, and dedicated lanes. In terms of optical guidance for transit systems, the state-of-the-art is a technology that can distinguish high contrast paints from the roadway, although the setup maintains the requirement of a human operator. (Duffy 2002) In the field of optical guidance by object recognition, the cutting edge is final target selection within advanced weapon systems.

Vehicle automation is a central objective to deploying an optimal transit system. Automation will minimize the major expense associated with human drivers, decentralized and 24-hour operation will be virtually unconstrained, advanced driving maneuvers can be employed that would otherwise be impractical for a human driver, there's high potential for increased safety, and advanced techniques, such as in-motion vehicle docking and passenger transfer, become possible.

A method has been formed for deploying an automated ground vehicle (AGV) that utilizes a specialized form of optical guidance known as Logic Driven Navigation (LDN). The method utilizes one or more digital cameras and stereoscopic algorithms to render an environment. The environment is then broken down into a basic mathematical construct, where object recognition techniques and situational planning are employed to guide a vehicle. No such concept has ever been proposed for vehicle guidance.

As a vehicle utilizing LDN would model an environment constantly, there are additional embodiments to be considered. This includes, however not limited to, individual/facial recognition, vehicle/license plate recognition, and general environmental mapping. The former two concepts have high potential in terms of national security, as in one invention embodiment a data tracking system could be developed that records the position of individuals and vehicles, scans exiting databases for lost persons, criminals, and terrorists, and records crime scene data to assist in criminal prosecutions. The later embodiment enables the construction of an extensive virtual representation of the real world. With the proper software platform and global deployment of LDN functional transit systems, a large portion of the globe could be accurately modeled.

Transfer Bridge

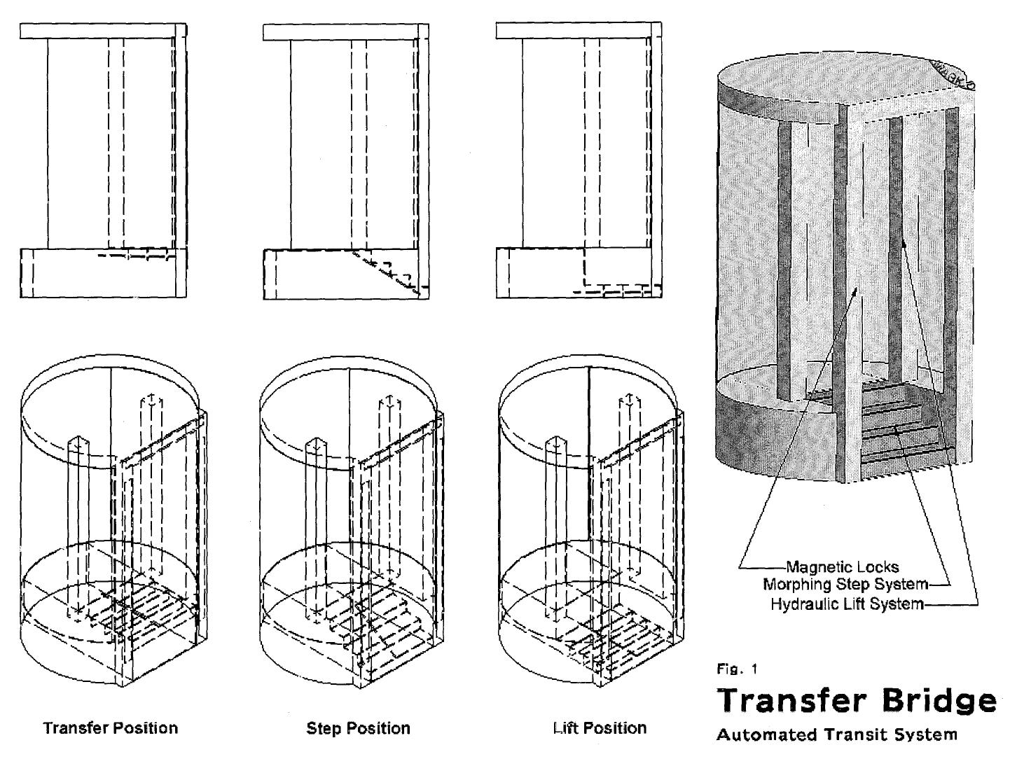

Discovering a means of rapid passenger transfer was essential in developing a transit system concept that could manage unilateral ridership. The ideal means of passenger transfer would be to do so while in-motion and among multiple vehicles. To overcome this challenge and enable rapid vehicle docking and passenger transfer, the concept of the Transfer Bridge was created. The Transfer Bridge is a computer guided, self-actuating linkage that utilizes a magnetic or any other applicable locking system, in coordination with drive and navigation system synchronization, to dock with alternate vehicles, particularly while in-motion. FIG. 1 illustrates the bridge's overall design and differing positions.

While concepts do exist for coupling and uncoupling cars in commuter rails systems in Europe and Asia, nowhere has the concept been applied to a guideless ground vehicle or any transit system that employs a dynamic operating model.

An additional advancement of the Transfer Bridge concept is its lifting capabilities. As FIG. 1 illustrates, a morphing step system is controlled by hydraulics located in each bridge column. When all hydraulics contract, the steps form the level surface necessary for in-motion transfer. When the forward hydraulic pair is extended, steps are formed. When all hydraulics extend, a level surface is created once again, only this surface is capable of extending to ground level and providing a flat surface for a person to walk or wheel ioto. Once on the platform, the bridge doors can close and lift the person to the level of the deck. Due to its innovative, heavy duty design, this lifting system would be ideal in the growing number of situations that involve lifting both persons and equipment of exceptional weight and dimension.

Vehicle Designs

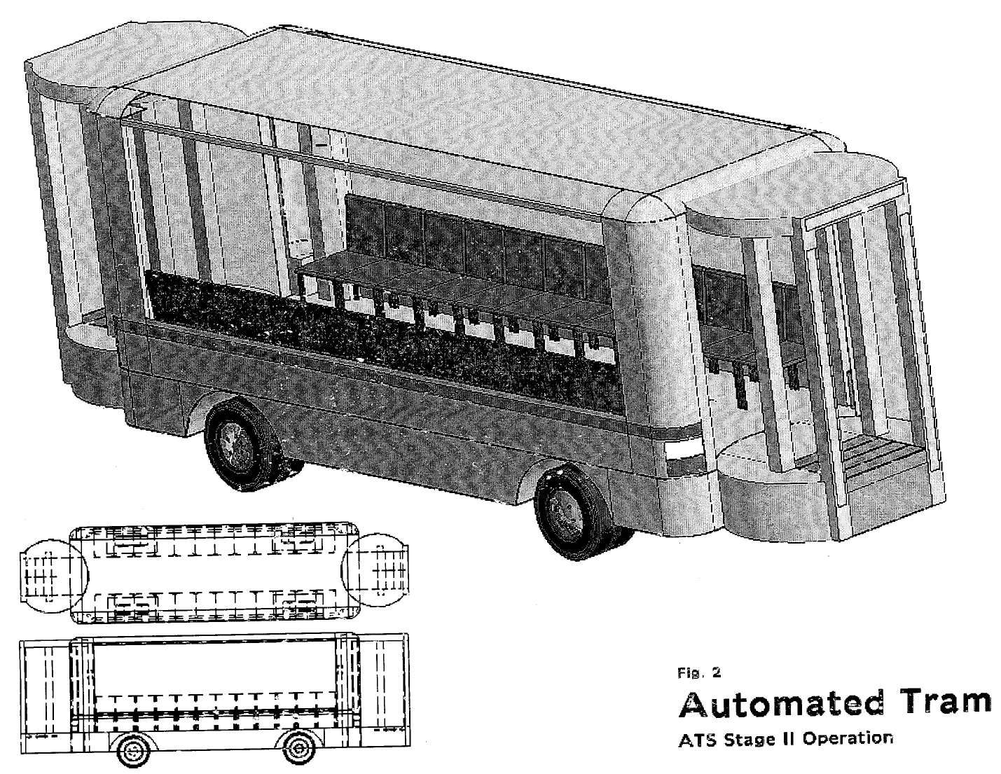

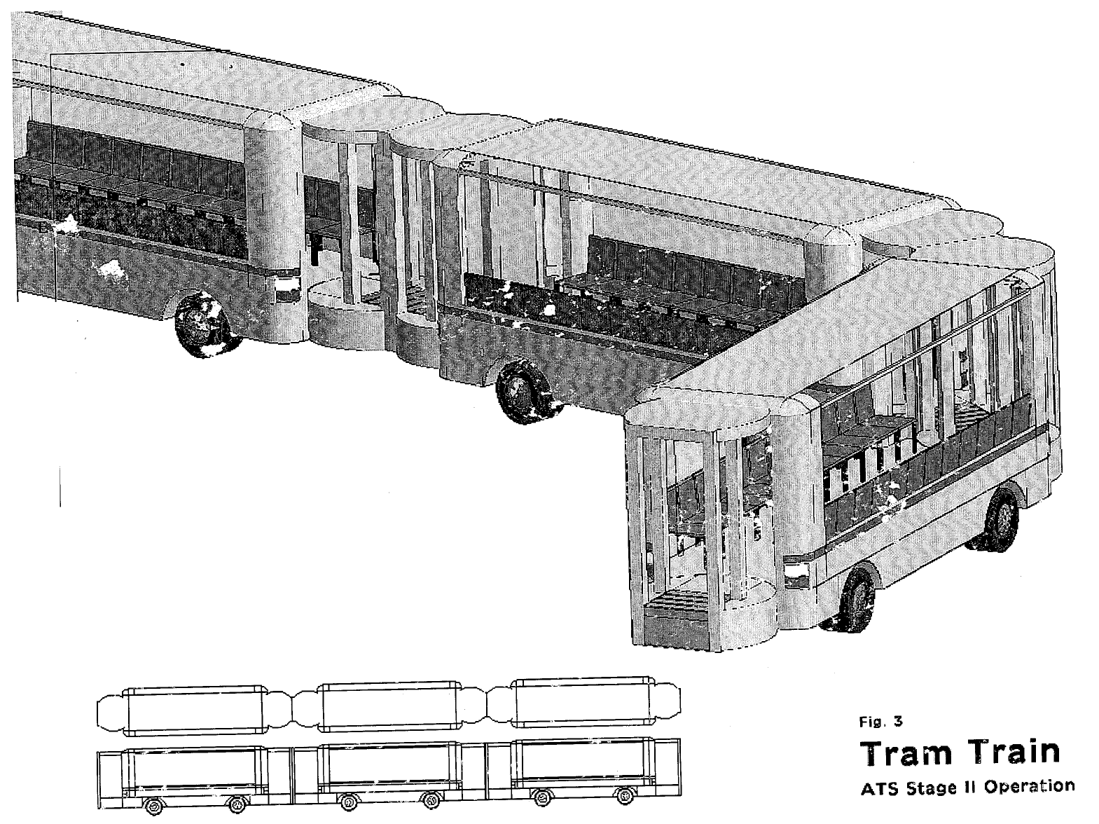

The amalgamation of the advanced technologies developed as a part of this multi-faceted invention for a next generation transit system have led to truly novel vehicle designs that fully embody the LDN and Transfer Bridge concepts. An example design is the Automated Tram, illustrated in FIG. 2. This is a mid-sized personnel transport. Transfer Bridges are located at both ends of the vehicle, enabling the Automated Tram to connect into variable size trains, illustrated in FIG. 3, and transfer passengers across multiple vehicles while in-motion. Additional embodiments include varying scale vehicles of similar design.

Novel Transit Business Models

Fundamental to this transit system is the software and communication (SC) infrastructure that will be developed and deployed to enable the coordination of vehicles and passengers as formerly discussed. Essentially, this component of the invention can be considered as a platform by which to develop and implement additional concepts that can further enhance the quality and capability of the transit system. New ways of doing business are but one example of how this potential can be realized.

In one embodiment, the SC infrastructure can be developed to provide a framework for merchants to market transit based incentives to customers. For example, a restaurant company may decide that there is value in marketing free transportation to their establishments. Intrinsically, this factor eliminates the key concern of intoxicated individuals driving an automobile, and thus opens up a profitable opportunity to increase alcohol sales. The firm, recognizing the benefits, purchases discounted transit credits. In the GTS, the individual locations of the firm's restaurants are identified. When a patron travels to any of these locations, their round trip fair is paid for on behalf of the restaurant. Additionally, while present at the establishment, a means of certifying patronage may be employed, such as using GPS positioning data to confirm the passenger's presence over a specific duration of time or by scanning their transit pass during check out. In any case, the passenger's fare to and from the sponsoring establishment is paid for by the merchant. The merchant has obtained service at a discount and added value, indirectly marketed the transit system, and generated additional business as they use this unique marketing tool to attract customers. Furthermore, there is no reason why multiple segments of a passenger's trip could not be covered by differing merchants.

In the process of developing market penetration strategies, a novel method for marketing transit service to potential organizational subscribers was devised. Using an address database of employees, it would be feasible to input this information into GTS and determine the necessary resources and costs of providing effective service based on the proposed operating model. To the customer, usage of the system can be justified in terms of reducing costs of living for employees, improving the company's community image, reducing the amount of property and infrastructure set aside for vehicle parking, and, potentially, increasing the overall productivity of employees by freeing them from driving and bringing them to work faster. The business model is further extensible in terms of investment. The funds necessary to expand service could be procured from a private firm, and it can be demonstrated that the utilization of these resources throughout the day for providing general public service will yield a return on their investment, a novelty for mass transportation indeed.

REFERENCES

U.S. Pat. No. 6,356,838, March 2002, Paul, 701/209

Dial, Robert B. (1995). “Autonomous dial-a-ride transit, introductory survey.” Transportation Research, Part C, 3(5), 261-275.

Duffy, Jim (2002). Las Vegas RTC. Mass Transportation, Volume XXVIII, No. 8, 24-26.

What is claimed is:

1. A computer-implemented method for determining like routes in close temporal proximity among passengers for a dynamically operating transportation system and performing the process of like route consolidation (LRC) optimization, transferring those passengers with like routes in close temporal proximity to the same vehicle. The method specifically entails:
collecting and compiling relevant data necessary to perform LRC optimization;
determining and executing operating patterns and transfers in accordance with LRC optimization;
impromptu transfers at locations, not limited to, predefined as acceptable transfer areas, driver selected locations or fixed stations;
combined application of LRC optimization techniques and in-motion passenger transfer;
process of directing passengers, particularly in real-time, in accordance with the dynamic plans and/or changes produced as a result of LRC optimization.

2. Development of a software and communications infrastructure that:
is capable of integrating multiple modes of transportation;
provides global accounts that streamline fare management for passengers, potentially across systems of varying ownership;
provides trip planning services, with the ability to preplan and/or request for service in real-time;
incorporates transit services that employ a model of dynamic operation that utilizes the process of LRC optimization discussed in claim 1;
optionally, provides features for analyzing future demand.

3. A computer-implemented method of providing incentives based on transportation utilization.

4. Process of linking vehicles to perform LRC optimization as discussed in claim 1, particularly vehicles in-motion.

5. Novel designs for next generation transit technologies and vehicle designs comprising:
Logic Drive Navigation (LDN), utilization of one or more digital cameras and stereoscopic algorithms to model an environment into a mathematical construct, enabling object recognition techniques and situational planning to guide a vehicle;
Transfer Bridge, a computer guided, self-actuating linkage that utilizes a magnetic or any other applicable locking system, in coordination with drive and navigation system synchronization, to dock with alternate vehicles, particularly while in-motion. Additionally, the morphing step and hydraulic system designs employed by the Transfer Bridge are key innovations that are independently applicable;
Automated Tram and variant vehicle designs, novel vehicle designs that incorporate logic driven navigation and/or the Transfer Bridge.

6. The application of any variant of LDN discussed in claim 5, affixed onboard a vehicle, to identify and/or track individuals and/or objects inside and/or out. Additionally, application to model an environment.
